(19) United States
(12) Patent Application Publication
(10) Pub. No.: US 2012/0060398 A1
(43) Pub. Date: Mar. 15, 2012

(54) Magnetic signs with replaceable messages

(76) Inventor: John Bowman, St. John, IN (US)

(21) Appl. No.: 13/200,665

(22) Filed: Sep. 28, 2011

Related U.S. Application Data
(63) Continuation-in-part of application No. 13/013,644, filed on Jan. 25, 2011.
(60) Provisional application No. 61/301,922, filed on Feb. 5, 2010.

(51) Int. Cl. G09F 7/04

(52) U.S. Cl. 40/600

(57) ABSTRACT

A sign utilizing interchangeable magnetic displays adhering to a ferromagnetic layer. The information, printed on the magnetic layers, retains their original freshness and crispness until removed and their magnetic replacements installed in their stead. Installing the new magnetic displays proves very facile and only requires removing the old magnetic display from its ferromagnetic panel and placing the new magnetic sign in its stead. The ferromagnetic panels can sit on top of regular signs or simply sit on the ground. In the latter instance, the ferromagnetic panel can sit in a frame that has a flat base that can simply rest on the ground, two runners to support the sign on the ground, or spikes attached to the runners that will penetrate soil to hold the sign. The frame may hold the ferromagnetic panel with its sign in a fixed position or allow it to rotate 180 degrees.

### CROSS REFERENCE TO RELATED APPLICATIONS

The present application constitutes a continuation-in-part of U.S. patent application Ser. No. 13/013,644, filed on Jan. 25, 2011, which claims the benefit of the filing of the U.S. provisional patent application No. 61/301,922 on Feb. 5, 2010.

### BACKGROUND

Commercial establishments of all sorts and types use signs and displays for various purposes. These range from simple permanent displays of the company's identification to advertisements of differing permanency promoting different items on limited-time specials. Further, seasonal preferences also induce limited-time displays; ice cream sells better in the summer.

The problem arises as to how to make use of changeable displays or signs without the hardware and the signs themselves looking cheap and impermanent which can only have a deleterious effect on the image of the establishment. Thus, signs with internal lighting and changeable messages have seen very substantial use. Examples of these include U.S. Pat. No. 7,308,769 to L. Labedz, and U.S. patent application publication US 2008/0236005 of I. Isayev et al. Separately, U.S. patent application publications US 2005/0229453 of D. U. Hillstrom, 2006/0010741 of A. K. Simson et al. and U.S. patents 3,374,566 to R. R. Snediker, 4,483,311 to R. E. Hosey et al., U.S. Pat. No. 4,592,530 to J. R. Seely et al., and U.S. Pat. No. 7,107,713 to A. K. Simson et al. show a holder that allows for the attachment of sign boards, possibly lighted, to the top of the usual, possibly internally lighted, signs and gas pumps, for example at a restaurant or gas station.

More recently, changeable signs employing coroplast (in effect, corrugated plastic) have found substantial use for changeable signs. With the desired display printed on sheets of the coroplast, the panels simply hang from a frame where the can undergo changing when the proprietor desires. However, signs made from coroplast suffer the drawbacks that they may appear less than substantial and may not survive adverse weather conditions. In fact, they can fold and “kink”, becoming unsightly in the process. Thus, the search continues for signs that undergo facile replacement yet prove simple to use, attractive, and durable.

### SUMMARY

A magnetic sign with replaceable messages includes first a substantially smooth, substantially rigid, substantially flat surface of ferromagnetic material of a specific, generally two-dimensional size and shape. A holding device holds the ferromagnetic surface at a substantially fixed location and orientation. A substantially flexible, magnetic, substantially two-dimensional sheet magnetically affixes to the flat ferromagnetic surface. Providing the magnetic sheet with substantially the two dimensional size and shape of the ferromagnetic surface provides an easily changeable yet attractive sign for commercial and other purposes.

Alternately, the holding device may have a substantially flat bottom surface. This will allow for the placing and retaining of the ferromagnetic surface on a substantially flat, horizontal retaining surface. As a result, the sign find use on the ground or at almost any location which has a flat surface.

As a further possibility and alternative, a securing device may permanently attach the ferromagnetic surface at a substantially fixed location and orientation relative to a structure having an elevation above the surrounding generally horizontal surface. This may serve, for example, to place and hold the magnetic on top of the usual, lighted sign at a drive-through location.

A method of displaying a sign includes first placing a holding device in contact with a surface. The holding device should have a substantially fixed location and orientation relative to that surface. A substantially smooth, substantially rigid, substantially flat surface of ferromagnetic material of a specific, generally two-dimensional size and shape is affixed to that holding device. Lastly, the process involves magnetically attaching a substantially flexible, magnetic, substantially two-dimensional sheet having substantially the two dimensional size and shape of the ferromagnetic surface to that surface.

Instead of the magnetic sheet having the size and shape of the ferromagnetic surface, the method may involve placing and retaining a supporting device having s substantially flat bottom in contact with a substantially flat surface and at a substantially fixed location and orientation relative to the surface. This will allow the proprietor to place the magnetic sign at a location suitable for his or her establishment. Further, when the establishment closes for the night, the proprietor may actually take the magnetic sign into a building for safe storage.

Or, the supporting device may be placed and retained in contact with a structure having an elevation relative to the surrounding generally horizontal surface. This will allow the placement of the magnetic sign, in particular, on top of the usual, back lighted display for further, timely information.

### BRIEF DESCRIPTION OF THE FIGURES

FIG. 1 gives a left-front isometric view of a sign employing a magnetic sheet with printing affixed to an underlying ferromagnetic surface attached to a frame sitting on a flat base.

FIG. 2 shows the placement of a magnetic display sign on the sign stand shown in FIG. 1.

FIG. 3 provides a cross-sectional view along the line 3-3 of the sign of FIG. 2.

FIG. 4 provides a left-front isometric partial view of the magnetic sign of FIG. 1 but attached to spike strips that can penetrate soil for stability.

FIG. 5 illustrates a partial end view of the sign of FIG. 2 along the line 5-5 with the spikes embedded in soil.

FIG. 6 provides a left-front isometric partial view of a magnetic sign similar to that of FIG. 2 but with feet instead of spikes so that the sign may sit on a flat, hard surface.

FIG. 7 gives an end view of the partial sign of FIG. 6 along the line 7-7 showing the feet of the sign sitting on an underlying surface.

FIG. 8 illustrates, in an isometric view taken from the left-front, a sign very similar to that of FIGS. 1 and 6 but making use of a taller ferromagnetic surface and magnetic sheet and with a flat base sitting on a flat surface.

FIG. 9 give a left, front perspective view of a sign very similar to the partial views of FIGS. 4 and 5 but in which the ferromagnetic surface and the magnetic sheet sitting to it may rotate within their frame to bring the back side as seen in the figures to the front for a full view of it.

FIG. 9A gives a cross sectional view along the line 9A-9A of the bottom pin structure that helps hold the bottom of the rotating signboard within its frame.

FIG. 10 provides a left, front perspective view of the sign of FIG. 9 but with the ferromagnetic surface and its magnetic sheets rotating in their frame.

FIG. 10A portrays, in an enlarged, exploded view, the spring-loaded pin structure that keeps the sign display from rotating when such rotation is not desired.

FIG. 11 gives a frontal, elevational view of the sign of FIGS. 9 and 10 in exploded form.

FIG. 11A illustrates, in an enlarged view, the encircled top pin structure that keeps the top of the rotating signboard within its frame.

### DETAILED DESCRIPTION

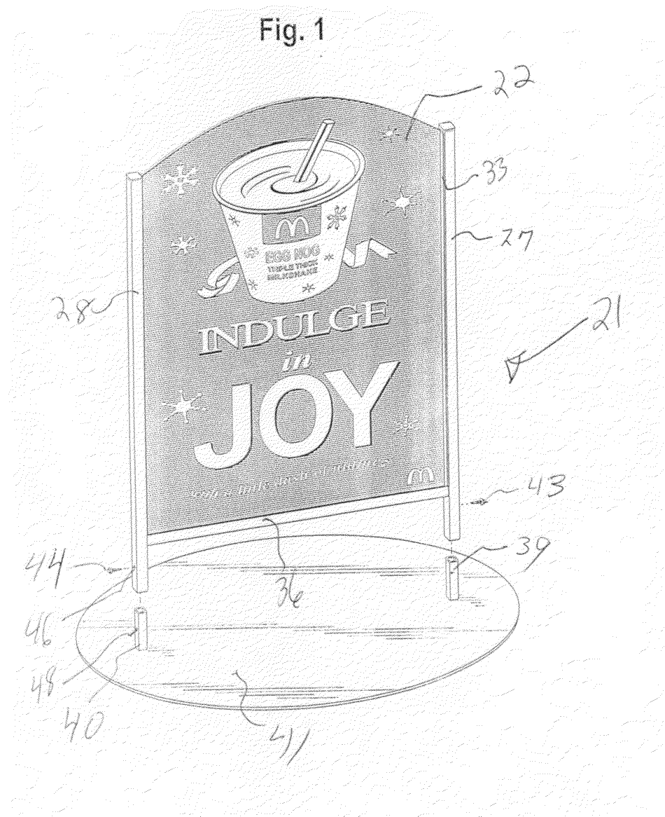

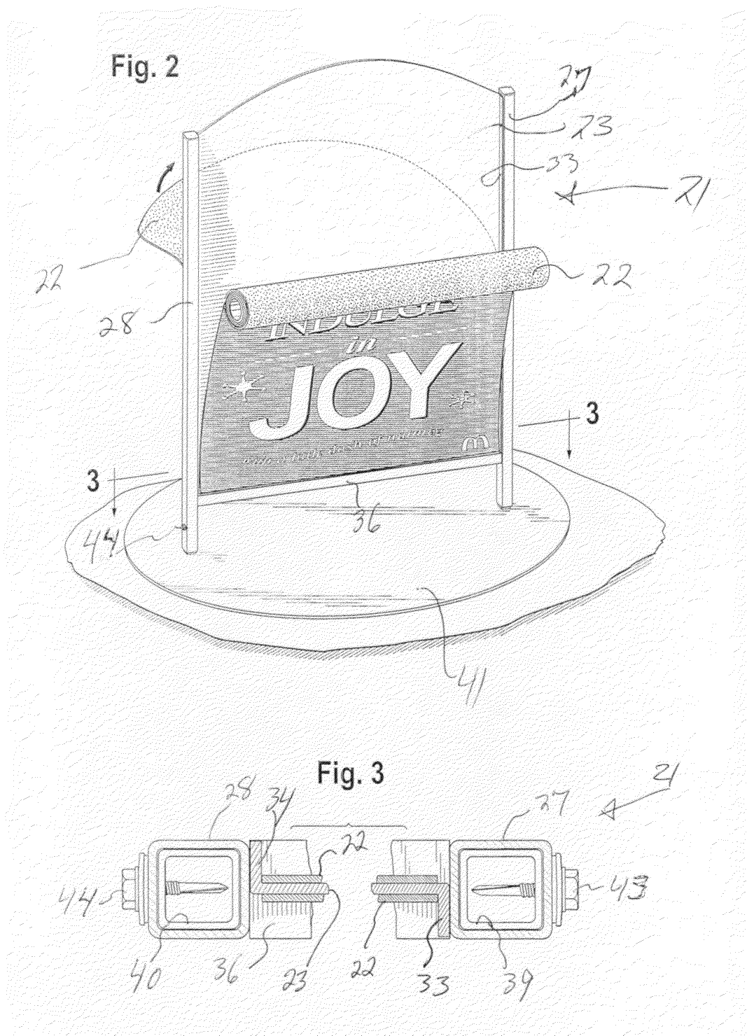

The magnetic sign, seen generally at 21 in FIGS. 1 and 2 and in the cross-sectional view of FIG. 3, includes the magnetic sheets 22 (seen clearly in FIGS. 2 and 3) that magnetically adhere to the flat surfaces of the ferromagnetic plate 23. As clearly seen in the first two of these figures, changing out the message on the sign simply involves removing the old, pliable magnetic sheet or sheets 22 and placing new ones in their stead.

To support the ferromagnetic plate 23 and thus the magnetic displays 22, the sign 22 includes the two posts 27 and 28 rigidly affixed to the plate 23. To assist in its attachment to the posts 27 and 28, the plate 23 includes the two bent edges 33 and 34, seen in FIG. 3. These edges may then attach to the posts 27 and 28, respectively, in any usual fashion such as by welding. To provide further rigidity, the bottom rail 36 extends between and attaches to the posts 27 and 28.

To support the sign 21 in an upright orientation, the posts 27 and 28, each having a hollow interior as seen in FIG. 3, fit respectively over and onto the projections or stubs 39 and 40 rigidly attached to and extending upwardly from the base 41. With the posts 27 and 28 sitting over the projections 39 and 40, the metal nuts 43 and 44 pass through the openings 46 (in FIG. 1) in the posts 27 and 28, and into the openings 48 in the projections 39 and 40 where their size keeps rigidly keeps them in place. Stated simply, the nuts 43 and 44 keep the posts 27 and 28, and thus the ferromagnetic plate 23, in place on the flat base 41.

In turn, the base 41 may sit on any convenient flat surface. Thus, the proprietor may place the sign near the driveway during business hours and then bring it inside when the establishment closes for the night.

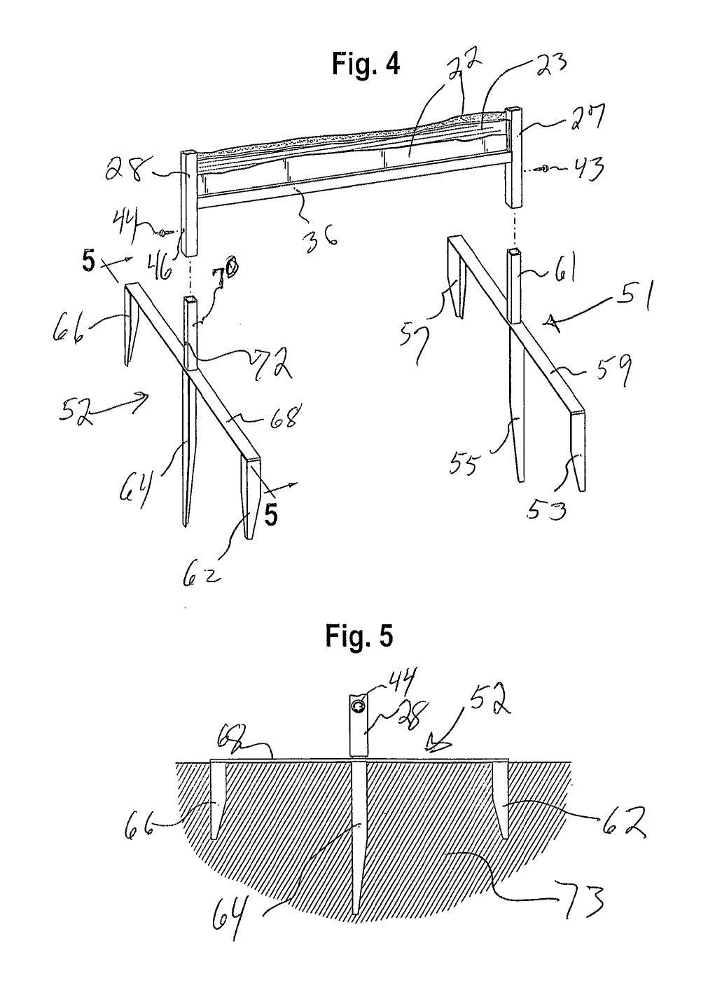

FIGS. 4 and 5 show an alternate base having the two spike strips seen generally at 51 and 52 in FIGS. 4 and 5. The spike strip 51 includes the three spikes 53, 55, and 57, the interconnecting runner 59, and the upstanding hollow stub 61. Similarly, the spike strip 52 has exactly the same construction as the strip 51. Thus, it includes the spikes 62, 64, and 66, the interconnecting runner 68, and the stub 70. In fact, the two spike strips 51 and 52 have exactly the same construction, but are turned around to face each other in actual use as shown.

The same ferromagnetic plate 23, magnetic signs 22, posts 27 and 28, and bottom rail 36 used in the sign 21 of FIGS. 1 to 3 can utilize the spike strips 51 and 52 of FIGS. 4 and 5. To do so, the hollow posts 27 and 28 fit onto the stubs 61 and 70. There the nuts 43 and 44 keep them in place. The latter nut 44 passes through the opening 46 in the post 28 and tightly into the opening 72 of the spike strip 52 to keep it in place there.

The use of the spike strips 51 and 52 starts with placing them at an appropriate distance apart from each other over penetrable soil. The “appropriate distance,” of course, means the distance that separates the posts 27 and 28 attached to the ferromagnetic plate 23. With the proper distance established between the posts 51 and 52, they are placed tightly into the soil. The posts 27 and 28 then fit over and onto the stubs 61 and 70 respectively. The nuts 43 and 44 pass through the posts 27 and 28, respectively, and into the stubs 61 and 70, respectively (with the nut also passing through the opening 72 of the latter stub 70) to hold the sign together. The spike strips 51 and 52 simply represent an alternative structure to hold a magnetic sign in the desired configuration such as upright.

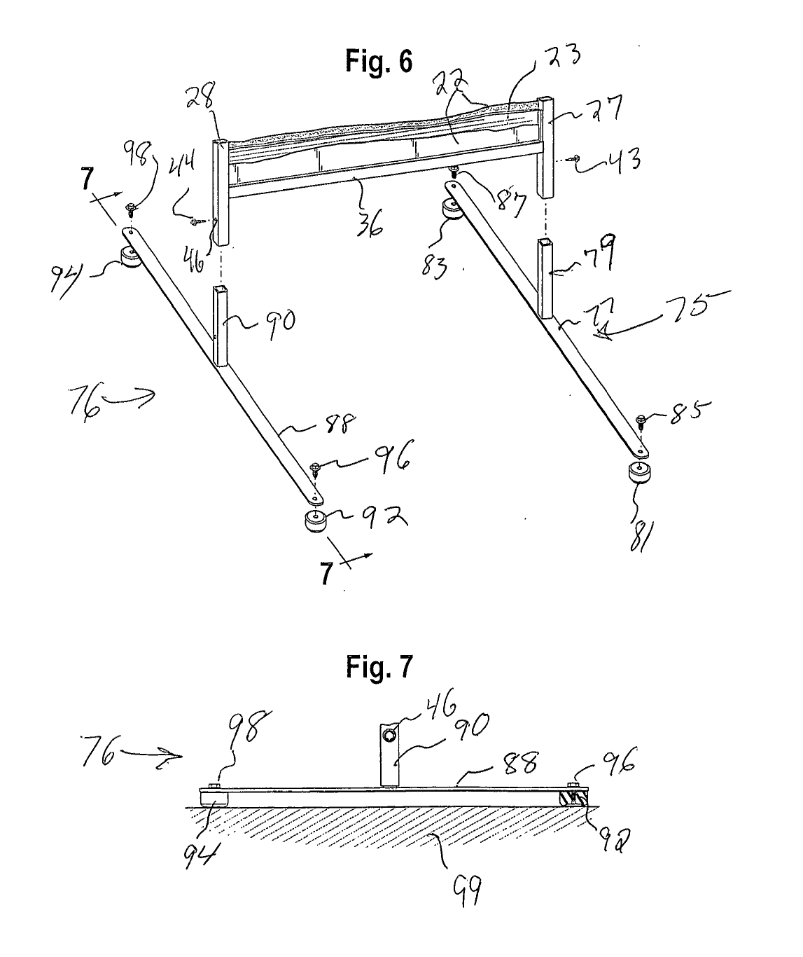

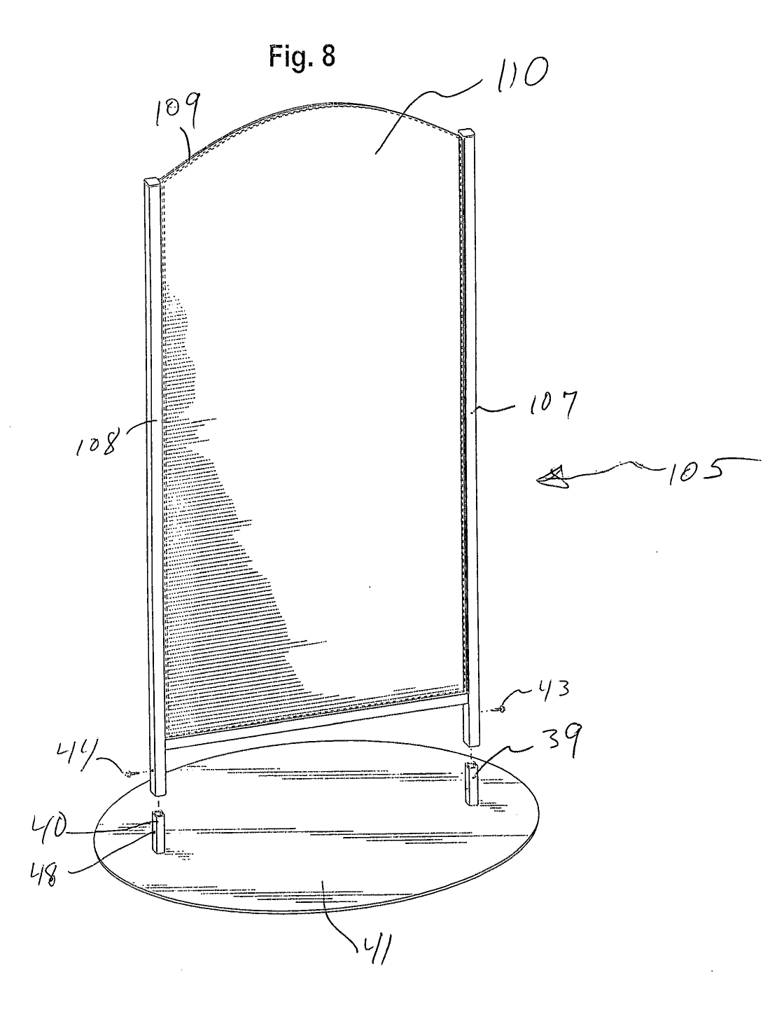

A further alternative structure which includes the flat runner strips, designated generally 75 and 76, for holding a magnetic sign upright for display appears in FIGS. 6 and 7. The flat runner strips 75 and 76 of FIGS. 6 and 7 take the place of the spike strips 51 and 52 of FIGS. 4 and 5 and the flat base 41 of FIGS. 1 to 3. As seen in FIGS. 6 and 7, the runner 75 includes the flat strip 77 to which is fixed the stub 79. Also, the rubber feet 81 and 83 are attached to the runner 77 by the nuts 85 and 87, respectively.

In the same fashion, the strip 76 includes the flat runner 88 to which attaches the stub 90. The rubber feet 92 and 94 are affixed to the strip 88 by the nuts 96 and 98, respectively.

To complete the sign, the hollow posts 27 and 28 fit over and into the hollow stubs 79 and 90. The nuts 43 and 44, respectively, pass the openings in the posts 27 and 28 and the through openings in the stubs 79 and 90, respectively, and keep the entire sign intact. In this form, the sign 76 may then be placed on the ground 99 which may take the form of a hard surface.

If desired, the posts 43 and 44 may be removed from the stubs 79 and 90 of FIGS. 6 and 7 and placde in some other base as the need arises. The prevailing conditions will indicate which base will prove most propitious.

FIG. 8 shows a sign indicated generally at 105 that appears very similar to the sign 21 of FIGS. 1 to 3. In FIG. 8, however, the posts 107 and 108 stand much taller than the posts 27 and 28 of the earlier figures. This, of course, results in a much taller ferromagnetic plate 109 and magnetic sign 110.

However, the separation between the posts 107 and 108 virtually equals that between the posts 27 and 28 of FIGS. 1 to 3. This allows them to fit into the stubs 39 and 40 of the very same base 41 used for the sign 21 of FIGS. 1 to 3. This interchangeability portends at least two significant advantages. First, for the sign manufacturer, the same base 41 can find use for differently sized signs such as those at 21 and 105. This will serve to reduce the amount of equipment and inventory required of the manufacturer and its distributors.

Second, an individual or business owning and using the smaller sign 21 of FIGS. 1 to 3 may wish to display, either permanently or from time to time (for special offers, for example), the larger sign 105 of FIG. 8. Making the switch proves facile. First, in FIGS. 1 to 3, the nuts 41 and 43 are unscrewed from the posts 27 and 28 and, thus, the stubs 39 and 40 of the base 41. The smaller display of FIGS. 1 to 3 is removed from the base 41, and the larger display of FIG. 8 placed on the base 41. This involves merely inserting the post 107 and 108 into the stubs 39 and 40 and screwing the nuts through the posts 107 and 108 and into the stubs 39 and 40.

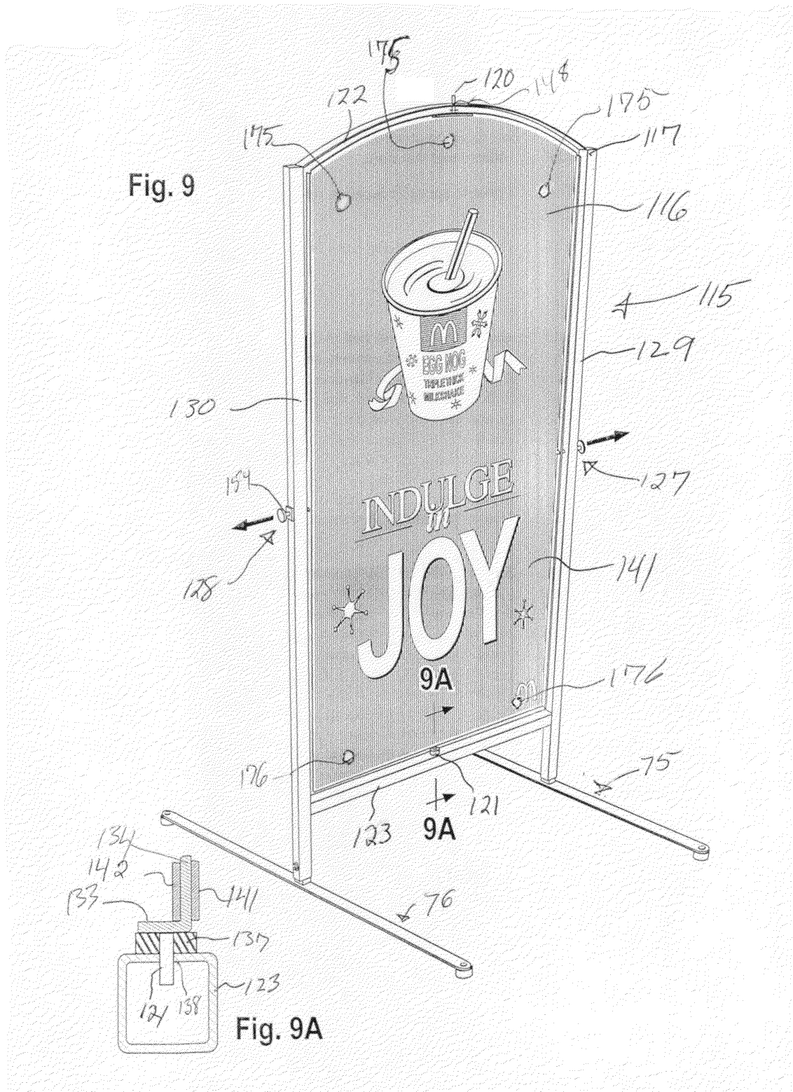

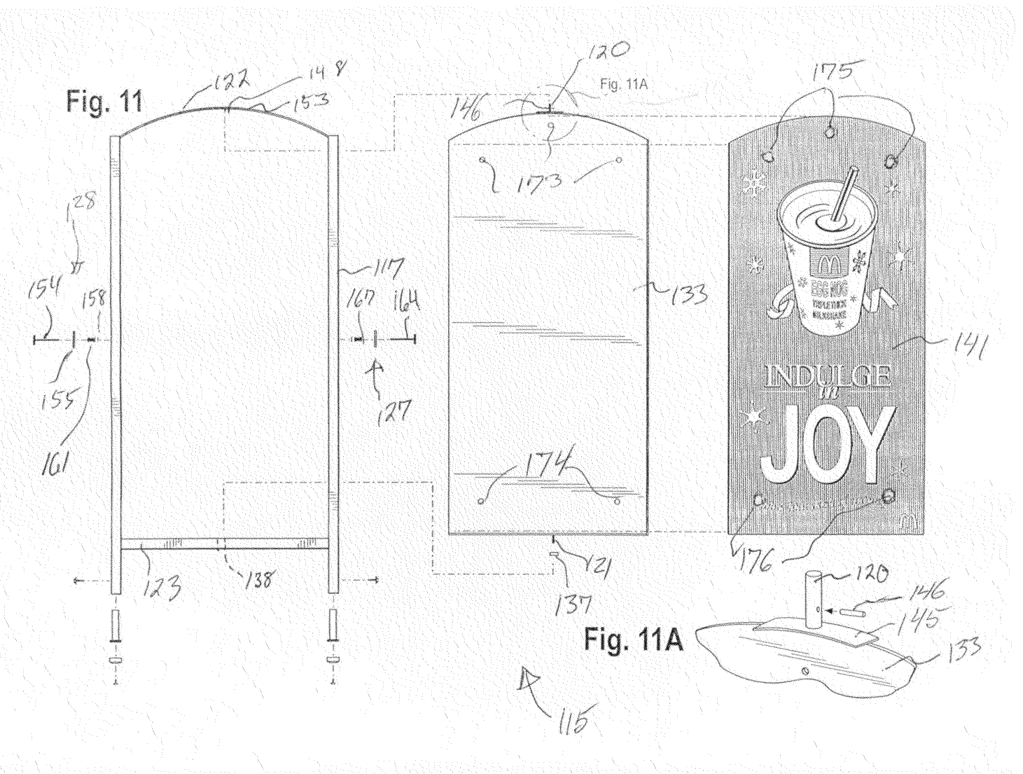

The sign indicated generally at 115 in FIGS. 9 to 11 has the additional advantage in that the signboard 116 may rotate 180 degrees to bring alternate messages into view as desired. Thus, in FIGS. 9 to 11, the signboard 116 sits in the frame 117. There, the upper and lower pins 120 and 121 sitting in the upper and lower frame members 122 and 123, respectively, keep it in place. The latter receives discussion below with regards to FIG. 9A, while the former is discussed in connection with FIG. 11A. As also discussed below, the spring-loaded pins indicated generally at 127 and 128 attach to the dual upright posts 129 and 130, respectively, and permit the signboard 116 to rotate within the frame 117 when desired, but keep it stationary at all other times.

To achieve this result and as seen in FIG. 9A, the pin 121 has a welded connection to the bottom flange 133 of the ferromagnetic plate 134. When installing the signboard 116, the pin 121 passes through the grommet 137 (for cushioning and lubrication) and into the opening 138 in the bottom beam 123. The opening 138 allows the pin 121 to sit comfortably within it which permits the signboard to rotate, as discussed below. The two magnetic displays 141 and 142 sit on opposite sides of the ferromagnetic plate 134. Rotating the signboard 116 removes one of the magnetic displays 141 and 142 from view and replaces it with the other.

Providing the second pivot point for the ferromagnetic plate 133, the pin 120 attaches to the top of that plate 133 as seen in FIG. 11A. In particular, it has a welded attachment to the small metal section 145 which in turn is welded to the plate 133.

Placing the plate 133 into the frame 117 involves removing the locking pin 146 from the larger pivot pin 120. The plate 133 is then maneuvered so that the pivot pin 120 enters the bottom of and then through the opening 148 at the middle (and thus the uppermost point) of the upper cross member 122. With the locking pin 146 removed from the upper pivot pin 120, the top 149 of the plate 133 may actually abut against the upper cross member 122 (with the upper pivot pin 120 in the opening 148). When this happens, the magnetic 133 plate sits high enough for the lower pivot pin 121 to enter the opening 138 in the lower cross member 123 of the frame 117. Lowering the plate 133 causes the lower pivot pin 121 to seat securely in the opening 138 in the lower cross member 123 and leaves the upper pivot pin 120 in the upper cross member 122. Then, replacing the locking pin 146 into the upper pivot pin 120 prevents the plate from rising to the point that the lower pivot pin 121 could come free from the lower frame cross member 123. This accordingly and rotatingly attaches the plate 116 to the frame 117.

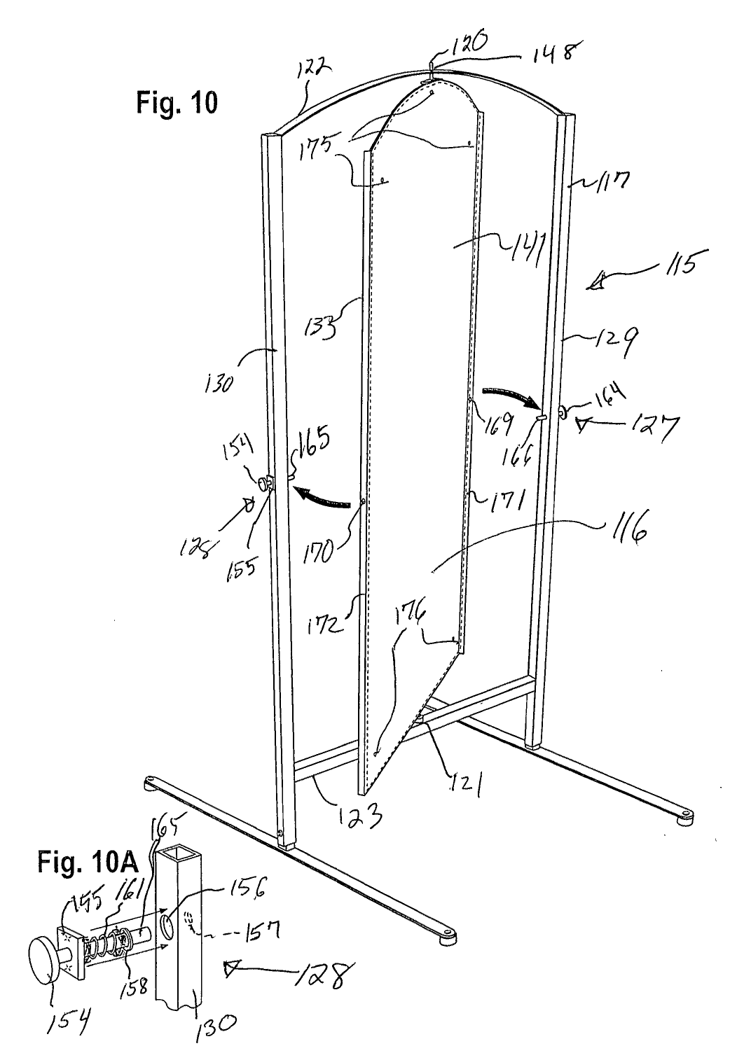

The job of controlling the rotation of the ferromagnetic plate 133 within the frame 117 falls to the two identical spring-loaded control pin assemblies 127 and 128. The latter appears in an exploded view in FIG. 10A. As seen there and somewhat in FIGS. 9 to 11, the control pin assembly 128 includes first the control pin 154 which passes through the metal piece 155 and through the openings 156 and 157 on opposite sides of the upright member 130. The opening 156 on the outside of the member 130 has a sufficient size to allow the washer 158 affixed or even welded to the pin 154 to pass through. However, the opening 157 on the inside of the upright 130 does not. Thus, inserting the pin 154 through the openings 156 and 157 will trap the washer 158 inside the interior of the upright member 130.

Meanwhile, the spring 161 sits on the control pin 128 between the metal piece 155 and the washer 158, which, as stated above, is permanently attached to the stem of the pin 154. With these components, the assembly of the control pin 154 with its spring 161 and the attached washer 158 is inserted into the opening 156 until the end of the pin 154 exits through the smaller opening 157 on the inside of the member 130. Welding the plate 155 to the outside of the upright post 130 then traps the washer 158 and the spring 161, on the pin 154, between the outside opening 156 and the inside opening 157 of the post 130.

The spring 161 pushes against both the washer 158 and the metal piece 155, forcing them apart. Pulling on the knob 154 will overcome the force of the spring 161, allow the knob 154 to move outward from the upright post, and retract the end 165 of the pin 154 away from the opening 170 in the flange 172 and into the post 130.

With this structure, the operation of the rotation of the signboard 116 submits to facile understanding. As shown in FIG. 9, the signboard 116, in its usual situation, sits fixed in the orientation between the posts 117 and 118 shown in FIG. 9. To rotate the board 116, the pins 154 and 164 are manually pulled away from the posts 117 and 118, respectively, overcoming the force of the springs 161 and 167 in the process. This retracts the ends of the pins from the openings 169 and 170 in the flanges 171 and 172, respectively. This frees the board 116 to rotate about the pins 120 and 121, best seen in FIG. 11.

After the board has rotated 180 degrees, the pins 154 and 164 are carefully released so that the springs 161 and 167 will force the ends 165 and 166, respectively, of the control pins 154 and 164, back outward and into the openings 170 and 169, respectively, in the flanges 172 and 170 to keep the board 116 in its new orientation. This, of course, brings the former backside of the signboard 116 into view.

As seen in the exploded view of FIG. 11, the ferromagnetic plate 133 includes the openings 173 and 174 at its top and bottom, respectively. With the magnetic display 141 properly aligned on the plate, these openings align with the openings 175 and 176 on the former. These openings 173 to 176 have the purpose of permitting the attachment of others signs and notices in front of the magnetic sign 141. Because of the openings 173 to 176, these additional signs and notices need not have any magnetic property at all. They thus may make use of even coroplast for this purpose.

The sign 115 of FIGS. 9 to 11 sits on the runners 76 and 77 of FIGS. 6 and 7. There, the nuts 43 and 44 keep it in place on the runners. Alternately, the sign 115 could make use of the flat base 41 of FIGS. 1 and 2 or the spike strips 51 and 52 of FIGS. 4 and 5.

What is claimed is:

1. A sign comprising:
A. a substantially smooth, substantially rigid, substantially flat surface of ferromagnetic material of a specific, generally two-dimensional size and shape;
B. holding means for holding said ferromagnetic surface at a substantially fixed location and orientation; and
C. a substantially flexible, magnetic, substantially two-dimensional sheet having substantially said two dimensional size and shape magnetically affixed to said substantially flat ferromagnetic surface.

2. The sign of claim 1 wherein said holding means comprises a first substantially rigid member coupled to one side of said ferromagnetic surface and a second rigid member coupled to a second side of said ferromagnetic surface, and interconnecting means coupled to said first and second posts for holding said first and second posts at a substantially fixed orientation relative to each other.

3. The sign of claim 2 wherein said interconnecting means includes third and fourth rigid members separated from each other and both coupled to said first and second rigid members to form a frame structure.

4. The sign of claim 3 wherein said ferromagnetic surface is rigidly affixed to said first and second rigid members.

5. The sign of claim 4 wherein said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

6. The sign of claim 4 wherein said first and second rigid members are respectively coupled to first and second spike means for penetrating soil where said sign sits.

7. The sign of claim 4 wherein said first and second rigid members couple to a flat seating surface means for sitting upon a flat, substantially horizontal retaining surface.

8. The sign of claim 4 wherein said first member couples to a first flat seating surface means and said second rigid members couples to a second flat seating surface means, and said first and second seating surface means both sit substantially flat upon a flat surface.

9. The sign of claim 3 wherein said ferromagnetic surface is rotationally coupled to said third and fourth rigid members.

10. The sign of claim 9 further including stabilizing means coupled to said ferromagnetic surface and said frame for selectively preventing rotation of said ferromagnetic surface relative to said frame.

11. The sign of claim 10 said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

12. The sign of claim 10 wherein said first and second rigid members are respectively coupled to first and second spike means for penetrating soil where said sign sits.

13. The sign of claim 10 wherein said first and second rigid members couple to a flat seating surface means for sitting upon a flat, substantially horizontal retaining surface.

14. The sign of claim 10 wherein said first member couples to a first flat seating surface means and said second rigid members couples to a second flat seating surface means, and said first and second seating surface means both sit substantially flat upon a flat surface.

15. The sign of claim 1 wherein said holding means includes gripping means, coupled to said holding means, for attaching said ferromagnetic surface to a structure at an elevation above the level of the surface surrounding said structure.

16. A sign comprising:
A. a substantially smooth, substantially rigid, substantially flat surface of ferromagnetic material of a generally two-dimensional size and shape;
B. holding means having a substantially flat bottom surface for placing and retaining said ferromagnetic surface on a substantially flat, substantially horizontal retaining surface; and
C. a substantially flexible, magnetic, substantially two-dimensional sheet magnetically affixed to said substantially flat ferromagnetic surface.

17. The sign of claim 16 wherein said holding means comprises a first substantially rigid member coupled to one side of said ferromagnetic surface and a second rigid member coupled to a second side of said ferromagnetic surface, and interconnecting means coupled to said first and second posts for holding said first and second posts at a substantially fixed orientation relative to each other.

18. The sign of claim 17 wherein said interconnecting means includes third and fourth rigid members separated from each other and both coupled to said first and second rigid members to form a frame structure.

19. The sign of claim 18 wherein said ferromagnetic surface is rigidly affixed to said first and second rigid members.

20. The sign of claim 19 said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

21. The sign of claim 19 wherein said first and second rigid members are respectively coupled to first and second spike means for penetrating soil where said sign sits.

22. The sign of claim 19 wherein said first and second rigid members couple to a flat seating surface means for sitting upon a flat, substantially horizontal retaining surface.

23. The sign of claim 19 wherein said first member couples to a first flat seating surface means and said second rigid members couples to a second flat seating surface means, and said first and second seating surface means both sit substantially flat upon a flat surface.

24. The sign of claim 18 wherein said ferromagnetic surface is rotationally coupled to said third and fourth rigid members.

25. The sign of claim 24 further including stabilizing means coupled to said ferromagnetic surface and said frame for selectively preventing rotation of said ferromagnetic surface relative to said frame.

26. The sign of claim 25 said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

27. The sign of claim 25 wherein said first and second rigid members are respectively coupled to first and second spike means for penetrating soil where said sign sits.

28. The sign of claim 25 wherein said first and second rigid members couple to a flat seating surface means for sitting upon a flat, substantially horizontal retaining surface.

29. The sign of claim 25 wherein said first member couples to a first flat seating surface means and said second rigid members couples to a second flat seating surface means, and said first and second seating surface means both sit substantially flat upon a flat surface.

30. The sign of claim 16 wherein said holding means retains said ferromagnetic surface on said retaining surface in a generally vertical direction.

31. A sign comprising:
A. a substantially smooth, substantially rigid, substantially flat surface of ferromagnetic material of a specific, generally two-dimensional size and shape;
B. securing means for permanently attaching said ferromagnetic surface at a substantially fixed location and orientation relative to a structure having an elevation above the surrounding generally horizontal surface; and
C. a substantially flexible, magnetic, substantially two-dimensional sheet magnetically affixed to said substantially flat ferromagnetic surface.

32. The sign of claim 31 wherein said holding means comprises a first substantially rigid member coupled to one side of said ferromagnetic surface and a second rigid member coupled to a second side of said ferromagnetic surface, and interconnecting means coupled to said first and second posts for holding said first and second posts at a substantially fixed orientation relative to each other.

33. The sign of claim 32 wherein said interconnecting means includes third and fourth rigid members separated from each other and both coupled to said first and second rigid members to form a frame structure.

34. The sign of claim 33 wherein said ferromagnetic surface is rigidly affixed to said first and second rigid members.

35. The sign of claim 34 said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

36. The sign of claim 34 wherein said structure having an elevation above the surrounding generally horizontal surface comprises sign means for conveying information.

37. The sign of claim 33 wherein said ferromagnetic surface is rotationally coupled to said third and fourth rigid members.

38. The sign of claim 37 further including stabilizing means coupled to said ferromagnetic surface and said frame for selectively preventing rotation of said ferromagnetic surface relative to said frame.

39. The sign of claim 38 wherein said substantially flexible, magnetic, substantially two-dimensional sheet is a first sheet and further including a second substantially flexible, magnetic, substantially two-dimensional sheet magnetically affixed to said substantially flat ferromagnetic surface on the side opposite to said first magnetic sheet.

40. The sign of claim 38 wherein said first and second rigid members couple to a flat seating surface means for sitting upon a flat, substantially horizontal retaining surface.

41. The sign of claim 38 wherein said first member couples to a first flat seating surface means and said second rigid members couples to a second flat seating surface means, and said first and second seating surface means both sit substantially flat upon a flat surface.

42. A method of displaying a sign comprising:
A. placing a holding means in contact with a surface at a substantially fixed location and orientation relative to said surface;
B. affixing to said holding means a substantially smooth, substantially rigid, substantially flat surface of ferromagnetic material of a specific, generally two-dimensional size and shape; and
C. magnetically attaching to said holding means a substantially flexible, magnetic, substantially two-dimensional sheet having substantially said two dimensional size and shape.

43. The method of claim 42 wherein said holding means comprises a first substantially rigid member coupled to one side of said ferromagnetic surface, a second rigid member coupled to a second side of said ferromagnetic surface, and interconnecting means coupled to said first and second posts for holding said first and second posts at a substantially fixed orientation relative to each other.

44. The method of claim 43 wherein said interconnecting means includes third and fourth rigid members separated from each other and both coupled to said first and second rigid members to form a frame structure.

45. The method of claim 44 further including rigidly affixing said ferromagnetic surface to said first and second rigid members.

46. The method of claim 45 wherein said substantially flexible, magnetic, substantially two-dimensional sheet is a first sheet and further including rigidly affixing a second substantially flexible, magnetic, substantially two-dimensional sheet magnetically to said substantially flat ferromagnetic surface on the side opposite to said first magnetic sheet.

47. The method of claim 45 further including coupling said first and second rigid members respectively to first and second spike means for penetrating soil where said sign sits.

48. The method of claim 45 further including coupling said first and second rigid members to a flat seating surface means for sitting upon a flat, substantially horizontal retaining surface.

49. The method of claim 45 further including coupling said first member to a first flat seating surface means and said second rigid members to a second flat seating surface means, where said first and second seating surface means both sit substantially flat upon a flat surface at the same time.

50. The method of claim 44 further including rotationally coupling said ferromagnetic surface to said third and fourth rigid members.

51. The method of claim 50 further including selectively preventing rotation of said ferromagnetic surface relative to said frame.

52. The method of claim 51 wherein said substantially flexible, magnetic, substantially two-dimensional sheet is a first sheet and further including magnetically affixing a second substantially flexible, magnetic, substantially two-dimensional sheet to said substantially flat ferromagnetic surface on the side opposite to said first magnetic sheet.

53. The method of claim 51 wherein said first and second rigid members are respectively coupled to first and second spike means and further including penetrating said spike into soil where said sign sits.

54. The method of claim 51 further including coupling said first and second rigid members couple to a flat seating surface means for sitting upon a flat, substantially horizontal retaining surface and placing said seating surface upon a flat, substantially horizontal surface.

55. The method of claim 51 further including coupling said first member to a first flat seating surface means, said second rigid members couples to a second flat seating surface means, and seating said first and second seating surface means substantially flat upon a flat surface.

56. The method of claim 42 further including attaching said ferromagnetic surface to a structure at an elevation above the level of the surface surrounding said structure.

57. A method of displaying a sign comprising:
A. placing and retaining a supporting means having s substantially flat bottom in contact with a substantially flat surface and at a substantially fixed location and orientation relative to said surface;
B. affixing to said supporting means a substantially smooth, substantially rigid, substantially flat surface of ferromagnetic material of a generally two-dimensional size and shape; and
C. magnetically attaching to said ferromagnetic surface a substantially flexible, magnetic, substantially two-dimensional sheet.

58. The method of claim 57 wherein said holding means comprises a first substantially rigid member coupled to one side of said ferromagnetic surface, a second rigid member coupled to a second side of said ferromagnetic surface, and interconnecting means coupled to said first and second posts for holding said first and second posts at a substantially fixed orientation relative to each other.

59. The method of claim 58 wherein said interconnecting means includes third and fourth rigid members separated from each other and both coupled to said first and second rigid members to form a frame structure.

60. The method of claim 59 further including rigidly affixing said ferromagnetic surface to said first and second rigid members.

61. The method of claim 60 wherein said substantially flexible, magnetic, substantially two-dimensional sheet is a first sheet and further including rigidly affixing a second substantially flexible, magnetic, substantially two-dimensional sheet magnetically to said substantially flat ferromagnetic surface on the side opposite to said first magnetic sheet.

62. The method of claim 60 further including coupling said first and second rigid members respectively to first and second spike means for penetrating soil where said sign sits.

63. The method of claim 60 further including coupling said first and second rigid members to a flat seating surface means for sitting upon a flat, substantially horizontal retaining surface.

64. The method of claim 60 wherein said supporting means includes first and second flat surface means and further including coupling said first rigid member to a first flat seating surface means and said second rigid member to a second flat seating surface means, where said first and second seating surface means both sit substantially flat upon a flat surface at the same time.

65. The method of claim 59 further including rotationally coupling said ferromagnetic surface to said third and fourth rigid members.

66. The method of claim 65 further including selectively preventing rotation of said ferromagnetic surface relative to said frame.

67. The method of claim 66 wherein said substantially flexible, magnetic, substantially two-dimensional sheet is a first sheet and further including magnetically affixing a second substantially flexible, magnetic, substantially two-dimensional sheet to said substantially flat ferromagnetic surface on the side opposite to said first magnetic sheet.

68. The method of claim 66 wherein said first and second rigid members are respectively coupled to first and second spike means and further including penetrating said spike into soil where said sign sits.

69. The method of claim 66 further including coupling said first and second rigid members couple to a flat seating surface means for sitting upon a flat, substantially horizontal retaining surface and placing said seating surface upon a flat, substantially horizontal surface.

70. The method of claim 66 further including coupling said first member to a first flat seating surface means, said second rigid members couples to a second flat seating surface means, and seating said first and second seating surface means substantially flat upon a flat surface.

71. The method of claim 57 further including attaching said ferromagnetic surface to a structure at an elevation above the level of the surface surrounding said structure.

72. A method of displaying a sign comprising:
A. placing and retaining a supporting means in contact with a structure having an elevation relative to the surrounding generally horizontal surface;
B. permanently securing a substantially smooth, substantially rigid, substantially flat surface of ferromagnetic material to said supporting means; and
C. attaching to said ferromagnetic surface a substantially flexible, magnetic, substantially two-dimensional sheet.

73. The method of claim 72 wherein said holding means comprises a first substantially rigid member coupled to one side of said ferromagnetic surface, a second rigid member coupled to a second side of said ferromagnetic surface, and interconnecting means coupled to said first and second posts for holding said first and second posts at a substantially fixed orientation relative to each other.

74. The method of claim 73 wherein said interconnecting means includes third and fourth rigid members separated from each other and both coupled to said first and second rigid members to form a frame structure.

75. The method of claim 74 further including rigidly affixing said ferromagnetic surface to said first and second rigid members.

76. The method of claim 75 wherein said substantially flexible, magnetic, substantially two-dimensional sheet is a first sheet and further including rigidly affixing a second substantially flexible, magnetic, substantially two-dimensional sheet magnetically to said substantially flat ferromagnetic surface on the side opposite to said first magnetic sheet.

77. The method of claim 73 further including coupling said first and second rigid members to a flat seating surface means for sitting upon a flat, substantially horizontal retaining surface.

78. The method of claim 74 further including rotationally coupling said ferromagnetic surface to said third and fourth rigid members.

79. The method of claim 78 further including selectively preventing rotation of said ferromagnetic surface relative to said frame.

80. The method of claim 79 wherein said substantially flexible, magnetic, substantially two-dimensional sheet is a first sheet and further including magnetically affixing a second substantially flexible, magnetic, substantially two-dimensional sheet to said substantially flat ferromagnetic surface on the side opposite to said first magnetic sheet.

81. The method of claim 78 further including coupling said first and second rigid members couple to a flat seating surface means for sitting upon a flat, substantially horizontal retaining surface and placing said seating surface upon a flat, substantially horizontal surface.

82. The method of claim 78 further including coupling said first member to a first flat seating surface means, said second rigid members couples to a second flat seating surface means, and seating said first and second seating surface means substantially flat upon a flat surface.
